(19) United States
(12) Patent Application Publication
(10) Pub. No.: US 2024/0012144 A1
(43) Pub. Date: Jan. 11, 2024

(54) Method for Detecting an Object by Means of a Lighting Device and an Optical Sensor, Control Device for Carrying Out Such a Method, Detection Device With Such a Control Device and Motor Vehicle With Such a Detection Device

(71) Applicant: DAIMLER TRUCK AG, Leinfelden-Echterdingen (DE)

(72) Inventor: Fridtjof STEIN, Ostfildern (DE)

(21) Appl. No.: 18/251,804

(22) PCT Filed: Oct. 7, 2021
(86) PCT No.: PCT/EP2021/077661

§ 371 Date: May 4, 2023

(30) Foreign Application Priority Data
Nov. 9, 2020 (DE) 10 2020 006 880.4

(51) Int. Cl. G01S 17/46; G06V 10/141; G06V 20/58; G01S 17/89

(52) U.S. Cl. CPC G01S 17/46; G06V 10/141; G06V 20/58; G01S 17/89; G01S 17/931

(57) ABSTRACT

A method for detecting an object by a lighting device and an optical sensor. A controlling of the lighting device and of the optical sensor are temporally coordinated where the controlling is associated with a visible distance range. Comparing at least one image-side boundary of the visible distance range with a predetermined standard representation of the at least one boundary of the visible distance range. Searching for the object on the at least one boundary based on the comparing.

### BACKGROUND AND SUMMARY OF THE INVENTION

The invention relates to a method for detecting an object by means of a lighting device and an optical sensor, a control device for carrying out such a method, a detection device with such a control device and a motor vehicle with such a detection device.

Methods for detecting objects and tracking objects by means of a lighting device and an optical sensor are known. Such a method arises from the international patent application with the publication number WO 2017/009848 A1, in which a lighting device and an optical sensor are temporally coordinated in order to record a certain visible distance range in an observation area of the optical sensor, wherein the visible distance range arises from the temporal matching of the controlling of the lighting device and of the optical sensor. What is disadvantageous in this method is that no feedback occurs between the object detected and to be tracked, and the lighting device and the optical sensor.

From the publication “Gated2Depth: Real-Time Dense Lidar From Gated Images” by Tobias Gruber et al. (https://arxiv.org/pdf/1902.04997.pdf), a method arises for the creation of a recorded image with distance information in real time. This method is problematic in that it can only be operated in a range of up to 80 m.

The object of the invention is therefore to provide a method for detecting an object by means of a lighting device and an optical sensor, a control device for carrying out such a method, a detection device having such a control device and a motor vehicle having such a detection device, wherein the mentioned disadvantages are at least partially resolved, preferably avoided.

The object is in particular solved in that a method for detecting an object by means of a lighting device and an optical sensor is provided, wherein a controlling of the lighting device and of the optical sensor are temporally coordinated and the coordinated controlling is associated with a visible distance range. At least one image-side boundary of the visible distance range is compared with a predetermined standard representation of the at least one boundary of the visible distance range. Based on the comparison, an object is searched for on the at least one boundary, in particular on the at least one image-side boundary.

With the help of the method, it is advantageously possible to search for and to detect an object, in particular early on, in particular at a distant boundary of the visible distance range. For an early object recognition, it is advantageously possible to plan a traffic safety-optimising braking and/or evasion strategy. It is furthermore possible, due to the early object recognition, to precisely measure the detected object and to carry out tracking of the object with the help of further sensors, in particular radar sensors and/or lidar sensors.

In a preferred embodiment of the method, the optical sensor and the lighting device are arranged spatially spaced apart from each other, preferably the optical sensor and the lighting device are arranged with a spatial distance from each other that is as large as possible. Advantageously, a shadow is generated by an object by means of the spacing apart of the optical sensor and the lighting device, which is visible in the recorded image of the optical sensor. By means of the shadow, objects can thus also be detected, which have little or no contrast to the road surface.

The detecting of an object at the distant boundary of the visible distance range is dependent on the reflective properties and/or the brightness of the object. An object that is bright and/or has good reflective properties can be detected as soon as the object enters into the visible distance range at the distant boundary. An object that is dark and/or has poor reflective properties can then only be detected if a non-negligible part of the object and/or the shadow of the object is situated inside the visible distance range.

The detection of an object on a near boundary of the visible distance range is independent of the reflective properties and/or the brightness of the object.

The method for creating recorded images by means of a controlling, that is temporally coordinated, of a lighting device and of an optical sensor is in particular a method known as a gated imaging method; in particular, the optical sensor is a camera which is only sensitively activated in a certain, limited time period, which is referred to as “gated control”, the camera is thus a gated camera. The lighting device is also correspondingly temporally only controlled in a certain, selected time period, in order to illuminate an object-side scene.

In particular, by means of the lighting device, a predefined number of light pulses are also emitted, preferably each with a duration between 5 ns and 20 ns. The beginning and the end of the exposure of the optical sensor is coupled to the number and duration of the light pulses emitted. As a result, a certain visible distance range can be recorded by means of the temporal controlling on one hand of the lighting device and on the other hand of the optical sensor with a correspondingly defined spatial position, i.e., in particular certain distances of the near and of the distant boundary of the visible distance range from the optical sensor are recorded by the optical sensor.

The visible distance range is thereby the one—object-side—region in the three-dimensional space that is shown by means of the number and duration of the light pulses of the lighting device, in connection with the start and the end of the exposure of the optical sensor by means of the optical sensor in a two-dimensional recorded image on an image plane of the optical sensor.

Whenever we are talking about “object-side” here and in the following, a region in physical space is being discussed. Whenever we are talking about “image-side” here and in the following, a region on the image plane of the optical sensor is being discussed. The visible distance range is thereby given on the object side. This corresponds to an image-side region on the image plane, assigned by the laws of imaging, as well as the temporal controlling of the lighting device and of the optical sensor.

Depending on the start and the end of the exposure of the optical sensor, after the beginning of the lighting by means of the lighting device, light pulse photons hit the optical sensor. The further the visible distance range is distanced from the lighting device and the optical sensor, the longer the time duration until a photon, which is reflected in this distance range, hits the optical sensor. The temporal distance between an end of the lighting and a beginning of the exposure is therefore extended the further the visible distance range is distanced from the lighting device and from the optical sensor.

It is thus in particular possible according to an embodiment of the method to define the position and the spatial width of the visible distance range, in particular a distance between the near boundary and the distant boundary of the visible distance range, by means of a correspondingly suited selection of the temporal controlling of the lighting device on the one hand, and of the optical sensor on the other hand.

In a preferred embodiment of the method, the visible distance range is provided, wherein the temporal coordination of the lighting device on the one hand and of the optical sensor on the other hand is determined from this and is correspondingly specified.

The lighting device has, in a preferred embodiment, at least one surface emitter, in particular a so-called VCSE laser. Alternatively or additionally, the optical sensor is preferably a camera.

In one embodiment of the method, if an object is found, i.e., is detected, the detected object is classified. Preferably, the classification is carried out by means of a neural network or a deep learning method.

According to a development of the invention, it is provided that an image-side line that runs between an exposed area and a non-exposed area in the recorded image is determined as being the image-side boundary of the visible distance range. An object is detected based on a deviation of the image-side line from a horizontal course of the standard representation.

A predetermined standard representation of the at least one boundary of the visible distance range is, in particular, a horizontal line between the exposed area and the non-exposed area of the recorded image. If an object is situated on the at least one boundary of the visible distance range, then this object is visible in the recorded image. An object that is bright and/or has good reflective properties increases the exposed area of the recorded image and reduces the non-exposed area of the recorded image. An object that is dark and/or has poor reflective properties increases the non-exposed area of the recorded image and reduces the exposed area of the recorded image. In both cases, the image-side boundary of the visible distance range has a course that is different from a horizontal course. The object is advantageously detected based on this deviation.

According to a development of the invention, it is provided that an image-side evaluation area is determined, which has the at least one image-side boundary of the visible distance range. Furthermore, a column histogram for all the pixels associated with the evaluation area on the optical sensor is created by means of summation of the illumination intensities of the associated pixels, for every image column of the evaluation area. Based on a deviation of the column histogram from a level course, an object is detected.

In the context of the present technical teaching, a level course of a column histogram is a course in which all values lie in a predetermined interval. This in particular means that the values are constant within a predetermined tolerance. Alternatively, a level course of a column histogram is a course that can be interpolated with a predetermined maximum error by means of a horizontal line.

If an object is situated on the at least one boundary of the visible distance range, this object creates a clear deviation from a level course in the column histogram.

According to a development of the invention it is provided that, in the recorded image, a distance of the detected object from the optical sensor is determined. Furthermore, in the recorded image, an image-side vertical dimension of the object is determined, and, based on the distance and the image-side vertical dimension, approximately one object-side height of the detected object is estimated. It is advantageously possible to estimate a maximum possible object-side height of a detected object.

A method for determining the distance between the detected object and the optical sensor arises from the published German patent application DE 10 2020 002 994 A1. The image-side vertical dimension of the object can be determined directly in the recorded image.

In the context of the present technical teaching, an image-side distance between the optical sensor and a maximum object-side vertical dimension of the shadow of the object can preferably be determined from the image-side vertical dimension of the object.

In the context of the present technical teaching, the detected object is arranged in an x-y plane on the object side, and the lighting device is arranged at the height z_{B} above the x-y plane on a z axis. The distance x_{O} between the lighting device and/or the optical sensor and the detected object is measured in the x direction. In order to estimate the object-side height, in particular the maximum possible object-side height, of the detected object z_{O}, it is assumed that the object has no dimension in the x direction. By means of the intercept theorem, the height of the lighting device z_{B}, the height of the detected object z_{O}, the distance x_{O} and the maximum dimension of the shadow of the object x_{S} are placed in relation to each other. By means of the formula

$${z}_{O} = \frac{{z}_{B} ( {x}_{S} - {x}_{O} )}{{x}_{S}} \qquad ( 1 )$$

the object-side height z_{O} is then estimated. The estimation by means of the formula (1) always provides an object-side height z_{O} that is smaller than the height of the lighting device z_{B}.

According to a development of the invention, it is provided that a series of recorded images is taken if an object is detected on the distant boundary of the visible distance range as a first image-side boundary of the at least one image-side boundary. The near boundary of the visible distance range is analysed on the image side as a second image-side boundary of the at least one image-side boundary, wherein the image-side near boundary of the visible distance range is compared with a predetermined standard representation of the near boundary of the visible distance range. Based on the comparison, the detected object is searched for. The series of recorded images is ended if the detected object is found on the near boundary of the visible distance range. With the help of this development it is advantageously possible to detect an object both on the distant boundary of the visible distance range and also on the near boundary of the visible distance range.

According to a development of the invention, it is provided that, if an object is detected in a recorded image, both on the near boundary of the visible distance range and also on the distant boundary of the visible distance range, it is concluded that there is an object that cannot be driven over.

In the context of the present technical teaching, an object that cannot be driven over has an object-side height z_{O} that is larger than the height of the lighting device z_{B} or corresponds to the height of the lighting device z_{B}.

According to a development of the invention, it is provided that tracking an object is carried out for a detected object.

In a preferred embodiment of the method, tracking an object is carried out by means of a Kanade Lucas Tomasi method (KLT method).

According to a development of the invention, it is provided that the comparison of the at least one image-side boundary with the standard representation of the at least one boundary is carried out by means of a deep learning method and preferably with a neural network.

The object is also solved in that a control device is created that is configured for carrying out a method according to the invention or a method according to one or more of the previously described embodiments. The control device is preferably formed as a computing device, especially preferably as a computer, or as a control device, in particular as a control device of a motor vehicle. In connection with the control device, advantages in particular arise that have already been explained in connection with the method.

The object is also solved in that a detection device is provided that has a lighting device, an optical sensor and a control device according to the invention or a control device according to one or more of the previously described exemplary embodiments. The control device is preferably operatively connected with the lighting device and the optical sensor and configured for their respective controlling. In connection with the detection device, advantages in particular arise that have already been explained in connection with the method and the control device.

The object is lastly also solved in that a motor vehicle having a detection device according to the invention or a detection device according to one or more of the previously described exemplary embodiments is provided. In connection with the motor vehicle, advantages in particular arise that have already been explained in connection with the method, the control device and the detection device.

In an advantageous embodiment, the motor vehicle is formed as a lorry. However, it is also possible that the motor vehicle is a passenger car, a commercial vehicle, or other motor vehicle.

The invention is illustrated in greater detail below by means of the drawings.

### BRIEF DESCRIPTION OF THE DRAWINGS

FIG. 1 is a schematic representation of an exemplary embodiment of a motor vehicle with an exemplary embodiment of a detection device;

FIG. 2 is a schematic representation of a first and a second example of a recorded image with a visualisation of a distant boundary and a near boundary of a first visible distance range;

FIG. 3 is a schematic representation of a third example of a recorded image with a visualisation of a distant boundary and a near boundary of a second visible distance range;

FIG. 4 is a schematic representation of a fourth example of a recorded image;

FIG. 5 is a schematic representation of a fifth example of a recorded image and an example of a column histogram associated with this; and

FIG. 6 is a schematic representation of an example for the estimation of a height of a first object and of a second object.

### DETAILED DESCRIPTION OF THE DRAWINGS

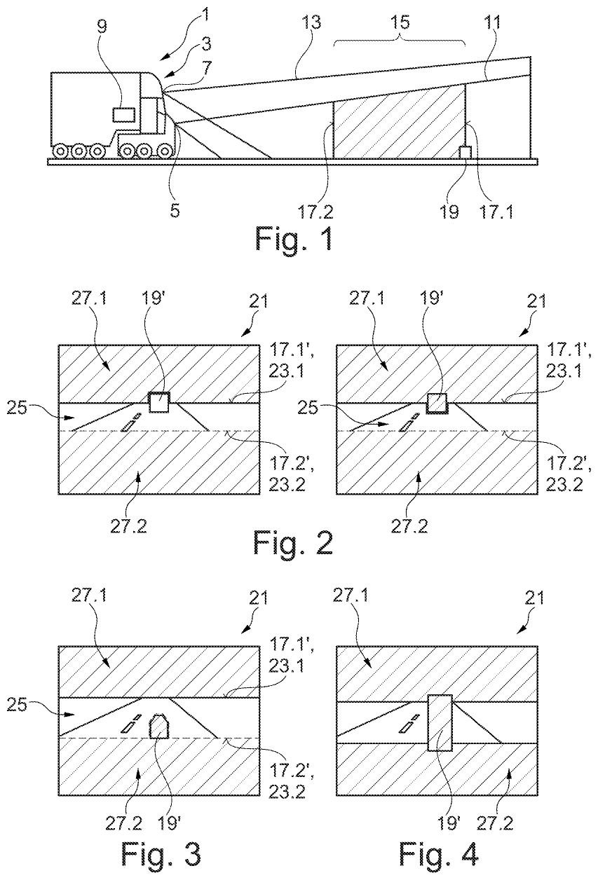

FIG. 1 shows a schematic representation of an exemplary embodiment of a motor vehicle 1 with an exemplary embodiment of a detection device 3. The detection device 3 has a lighting device 5, an optical sensor 7, in particular a camera, and a control device 9. The control device 9 is operatively connected with the lighting device 5 and the optical sensor 7 in a manner that is not explicitly shown and configured for their respective controlling.

The lighting device 5 preferably has at least one surface emitter, in particular a so-called VCSE laser.

A lighting frustum 11 of the lighting device 5 and an observation range 13 of the optical sensor 7 is in particular represented in FIG. 1. A visible distance range 15 is also shown cross-hatched, which arises as part of the lighting frustum 11 of the lighting device 5 and of the observation range 13 of the optical sensor 7. An object 19 is arranged on a distant boundary 17.1 of the visible distance range 15.

The control device 9 is in particular configured for carrying out an embodiment of a method for detecting the object 19 by means of the lighting device 5 and of the optical sensor 7 that is described in more detail in the following.

A controlling of the lighting device 5 and of the optical sensor 7 are temporally coordinated, and the coordinated controlling is associated with the visible distance range 15. At least one image-side boundary 17′, in particular the image-side distant boundary 17.1′ or the image-side near boundary 17.2′, of the visible distance range 15 is compared with a predetermined standard representation of the at least one boundary 17 of the visible distance range 15. Based on the comparison, the object 19 is searched for on the at least one boundary 17.

A series of recorded images 21 is preferably taken if the object 19 is detected on the distant boundary 17.1 of the visible distance range 15. Further, the near boundary 17.2 of the visible distance range 15 is analysed on the image side, wherein the image-side near boundary 17.2′ of the visible distance range 15 is compared with a predetermined standard representation of the near boundary 17.2 of the visible distance range 15. Based on the comparison, the object 19, which was previously detected on the distant boundary 17.1, is searched for. The series of recorded images 21 is ended if the object 19 is also detected on the near boundary 17.2 of the visible distance range 15.

Preferably, tracking the object is carried out for the detected object 19.

In FIGS. 2 and 3, a first embodiment of the comparison between the at least one image-side boundary 17′ of the visible distance range 15 and the predetermined standard representation of the at least one boundary 17 of the visible distance range 15 is shown. In a recorded image 21 of the optical sensor 7, an image-side line 23 is determined as being the image-side boundary 17′ of the visible distance range 15. The image-side line 23 runs between an exposed area 25 and a non-exposed area 27. The object 19 is detected based on a deviation of the image-side line 23 from a horizontal course of the standard representation.

In FIG. 2 a), a schematic representation of a first example of the recorded image 21 is shown. An image-side object 19′, which is bright and/or has good reflective properties, is arranged on the distant boundary 17.1 of the visible distance range 15. An image-side line 23.1 shows the image-side distant boundary 17.1′ of the visible distance range 15. An image-side line 23.2 shows the image-side near boundary 17.2′ of the visible distance range 15. The predetermined standard representation of both the distant boundary 17.1 and also the near boundary 17.2 is a line with a horizontal course. Due to the bright colour and/or the good reflective properties of the object 19, the image-side line 23.1 has an upwards protrusion in the region of the image-side object 19′, whereby the exposed area 25 is enlarged. Based on a deviation of the image-side line 23.1, in particular the protrusion, the object 19 is detected on the distant boundary 17.1 of the visible distance range 15.

In FIG. 2 b), a schematic representation of a second example of the recorded image 21 is shown. An image-side object 19′, which is dark and/or has poor reflective properties, is arranged on the distant boundary 17.1 of the visible distance range 15. Due to the dark colour and/or the poor reflective properties of the object 19, the image-side line 23.1 has a downwards protrusion in the region of the image-side object 19′, whereby the non-exposed area 27.1 is enlarged. Based on a deviation of the image-side line 23.1, in particular the protrusion, the object 19 is detected on the distant boundary 17.1 of the visible distance range 15.

A schematic representation of a third example of the recorded image 21 is shown in FIG. 3). An image-side object 19′, which is dark and/or has poor reflective qualities, is arranged on the near boundary 17.2 of the visible distance range 15. Due to the dark colour and/or the poor reflective properties and a shadow of the object 19, the image-side line 23.2 has an upwards protrusion in the region of the image-side object 19′, whereby the non-exposed area 27.2 is enlarged. Based on a deviation of the image-side line 23.2, in particular the protrusion, the object 19 is detected on the distant boundary 17.2 of the visible distance range 15.

FIG. 4 shows a schematic representation of a fourth example of the recorded image 21. In the recorded image 21, the non-exposed areas 27.1 and 27.2 are optically connected by means of the image-side object 19′, which is dark and/or has poor reflective properties. In this case, the object 19 is simultaneously detected in a single recorded image 21, both on the distant boundary 17.2 of the visible distance range 15 and also on the near boundary 17.2 of the visible distance range 15, and it is concluded that there is an object 19 that cannot be driven over.

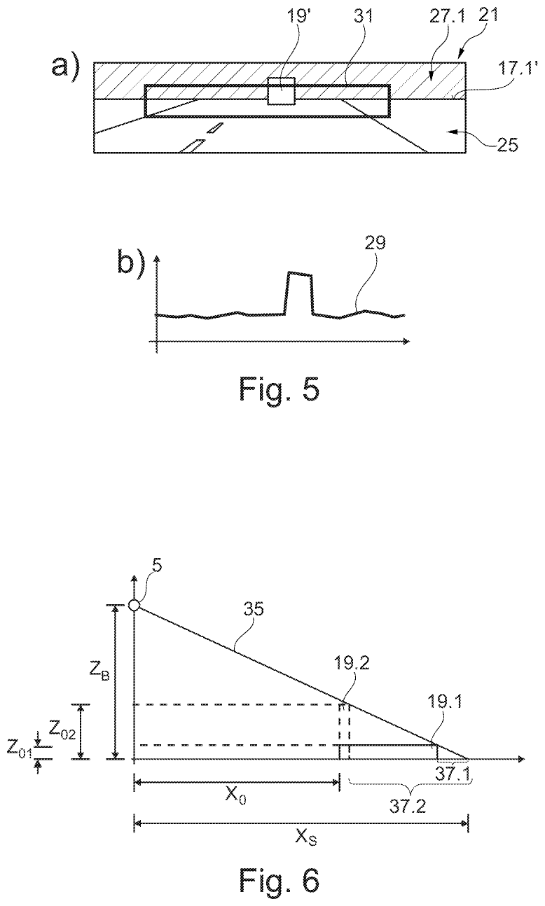

FIG. 5 shows a schematic representation of a fifth example of the recorded image 21 and an example of an associated column histogram 29.

In FIG. 5 a), a section of the recorded image 21 with the image-side distant boundary 17.1′ of the visible distance range 15 is shown. Further, the object 19 is arranged on the distant boundary 17.1 of the visible distance range 15 and is represented in the recorded image 21 as an image-side object 19′. An image-side evaluation area 31 is determined for detecting the object 19. The image-side evaluation area 31 is determined in such a way that the image-side distant boundary 17′ is kept in the evaluation area 31. The column histogram 29, shown in FIG. 5 b), for all the pixels associated with the evaluation area 31 on the optical sensor 7 is created by means of summation of the illumination intensities of the associated pixels, for every image column of the evaluation area 31. Based on a deviation of the column histogram 29 from a level course, an object 19 is detected.

The object 19 is bright and/or has good reflective properties, therefore a clear deviation upwards from a level course is visible in the column histogram 29. Based on this deviation of the column histogram 29 from a level course, the object 19 is detected.

FIG. 6 shows a schematic representation of an example for estimating a height of a first object 19.1 and of a second object 19.2. Both the first object 19.1 and also the second object 19.2 are an identical distance x_{O} from the lighting device 5. Shown by means of a beam of light 35, both the first object 19.1 and also the second object 19.2 have an identical dimension x_{S} of the shadow 37. By means of a suited method, both the distance x_{O} and also the image-side vertical dimension are determined. From the vertical dimension, the dimension x_{S} of the shadow 37 is calculated. Based on the distance x_{O} and the image-side vertical dimension, in particular the dimension x_{S} of the shadow 37, a height z_{O} of both objects 19 is approximately estimated, in particular by means of the formula (1), wherein the estimated height z_{O} is identical for both objects. The estimated height z_{O} is marginally larger than the actual height z_{O2} of the second object 19.2. However, the estimated height z_{O} is much larger than the actual height z_{O1} of the first object 19.1. It is thus clearly recognisable from FIG. 6 that the height of an object 19 is never underestimated when using the formula (1).

1.-10. (canceled)

11. A method for detecting an object (19) by a lighting device (5) and an optical sensor (7), comprising the steps of:
a controlling of the lighting device (5) and of the optical sensor (7) are temporally coordinated, wherein the controlling is associated with a visible distance range (15);
comparing at least one image-side boundary (17′) of the visible distance range (15) with a predetermined standard representation of the at least one boundary (17) of the visible distance range (15); and
searching for the object (19) on the at least one boundary (17) based on the comparing.

12. The method according to claim 11, wherein an image-side line (23) that runs between an exposed area (25) and a non-exposed area (27) in a recorded image (21) is determined as being the at least one image-side boundary (17′) of the visible distance range (15) and wherein the object (19) is detected based on a deviation of the image-side line (23) from a horizontal course of the predetermined standard representation.

13. The method according to claim 11, wherein:
an image-side evaluation area (31) of a recorded image (21) is determined which has the at least one image-side boundary (17′) of the visible distance range (15);
a column histogram (29) for all pixels associated with the evaluation area (31) on the optical sensor (7) is created by summation of respective illumination intensities of the associated pixels for every image column of the evaluation area (31);
the object (19) is detected based on a deviation of the column histogram (29) from a level course.

14. The method according to claim 11, wherein:
in a recorded image (21), a distance of a detected object (19) from the optical sensor (7) is determined;
in the recorded image (21), an image-side vertical dimension of the detected object (19) is determined;
based on the distance and the image-side vertical dimension, approximately one object-side height of the detected object (19) is estimated.

15. The method according to claim 11, wherein:
a series of recorded images (21) is taken if an object (19) is detected on a distant boundary (17.1) of the visible distance range (15) as a first image-side boundary (17.1′) of the at least one image-side boundary (17′);
a near boundary (17.2) of the visible distance range (15) is analysed on an image side as a second image-side boundary (17.2′) of the at least one image-side boundary (17′);
the image-side near boundary (17.2′) of the visible distance range (15) is compared with a predetermined standard representation of the near boundary (17.2) of the visible distance range (15);
the detected object (19) is searched for based on the comparison to the near boundary (17.2) of the visible distance range (15);
the series of recorded images (21) is ended if the detected object (19) is detected on the near boundary (17.2) of the visible distance range (15).

16. The method according to claim 11, wherein, if an object (19) is detected in a recorded image (21), both on a near boundary (17.2) of the visible distance range (15) and also on a distant boundary (17.1) of the visible distance range (15), it is concluded that there is an object (19) that cannot be driven over.

17. The method according to claim 11, wherein tracking an object is carried out for a detected object (19).

18. A control device (9) that is configured to perform the method according to claim 11.

19. A detection device (3), comprising:
a lighting device (5);
an optical sensor (7); and
a control device (9) that is configured to perform the method according to claim 11.
